(19) United States
(12) Patent Application Publication
(10) Pub. No.: US 2024/0222799 A1
(43) Pub. Date: Jul. 4, 2024

(54) BATTERY CELL NEGATIVE CONTACT

(71) Applicant: MILWAUKEE ELECTRIC TOOL CORPORATION, Brookfield, WI (US)

(72) Inventor: Kyle C. Fassbender, Brookfield, WI (US)

(21) Appl. No.: 18/399,139

(22) Filed: Dec. 28, 2023

Related U.S. Application Data
(60) Provisional application No. 63/435,843, filed on Dec. 29, 2022.

(51) Int. Cl. H01M 50/503; H01M 10/6554; H01M 50/213; H01M 50/505

(52) U.S. Cl. CPC H01M 50/503; H01M 10/6554; H01M 50/213; H01M 50/505

(57) ABSTRACT

The present disclosure is a battery cell module including a frame that defines a plurality of cell chambers and that supports a contact strap, and a plurality of battery cells that are supported in the cell chambers. The contact strap includes a plurality of contacts that are spaced along each of the cell chambers. The battery cells each include a positive terminal a first end, a second end that defines a negative terminal, and a cylindrical sidewall that electrically communicates the negative terminal. The plurality of contacts of the contact strap contacts the cylindrical sidewalls of the battery cells.

### CROSS-REFERENCE TO RELATED APPLICATIONS

This application claims priority to co-pending U.S. Provisional Patent Application No. 63/435,843, filed on Dec. 29, 2022, the entire contents of which are incorporated herein by reference.

### FIELD

The present disclosure relates to a battery cell contact, and in particular, the battery cell contact engaging the negative terminal of a battery cell.

### BACKGROUND

Cylindrical battery cells having a positive terminal defined at an end of the cylindrical battery cell and a negative terminal defined by the cylindrical sidewall and opposite end of the housing are often connected in parallel or series to form a battery cell module. Multiple battery cell modules may be combined to form a battery pack. The battery cell module offers the advantage of being able to combine common module components in different quantities of modules to form battery packs with different combined voltages.

The battery cells of the battery cell module are often electrically coupled to a positive busbar at a positive terminal contact point defined on the positive terminal of the battery cell, and to a negative busbar via a negative terminal contact point defined on the negative terminal (e.g., at the crimped portion of the battery cell housing adjacent the positive terminal).

A common assembly process of the above-described cell module includes the steps of welding positive and negative contacts to the respective positive and negative terminals at the positive and negative terminal contact points, as well as welding the positive and negative contacts to the respective positive and negative busbars. The welding process requires additional preparatory steps, such as laser cleaning, prior to welding the contacts to the positive and negative terminals.

In operation, the positive and negative contacts have an inherent resistance to the flow of electricity from the cells that is at least partially a result of the geometry of the contact coupling the battery cell to the busbars. As the power of each cell is discharged, heat is emitted, and builds up at the positive and negative terminal contact points. For battery cells with a compact contact area, the heat is concentrated at the compact contact area.

### SUMMARY

The present disclosure provides, in one aspect, a battery cell module including a frame, a contact strap, and a plurality of battery cells. The frame defines a plurality of cell chambers. The contact strap is supported in the frame. The contact strap includes plurality of contacts that are spaced along each of the cell chambers. Each of the battery cells has a positive terminal at a first end, an opposite second end that defines the negative terminal, and a cylindrical sidewall that electrically communicates the negative terminal. The battery cells are supported in the cell chambers and the plurality of contacts contact the cylindrical sidewalls of the battery cells.

The present disclosure provides, in another aspect, a battery cell module that comprises a plurality of battery cells, a frame, a contact strap supported in the frame, and a frame head. Each of the battery cells has a positive terminal at a first end, an opposite second end that defines the negative terminal, and a cylindrical sidewall that electrically communicates the negative terminal. The frame includes a plurality of cell chambers extending from insertion holes. The cell chambers receive the plurality of battery cells. The contact strap includes a base portion, a first set of a support arms that extend from a first side of the base portion, and a second set of support arms that extend from the opposite second side of the base portion. The second end of the battery cells contacts the base portion. Each of the support arms includes a plurality of contacts that extend from the support arm and are spaced along the length of the support arm. The contacts engage the cylindrical sidewall of the battery cell. A busbar portion couples ends of the support arms in the first set of support arms. The busbar portion includes a contact face that extends perpendicularly relative to the support arms. The frame head is coupled to the frame and includes a plurality of terminal holes aligned with the insertion holes.

The present disclosure provides, in another aspect, a battery cell stack that includes a plurality of battery cell modules and a heat sink that is coupled to the plurality of battery cell modules. The battery cell modules include a frame that defines a plurality of cell chambers, a contact strap supported in the frame, a plurality of battery cells, and a frame head. The contact strap includes a plurality of contacts spaced along each of the cell chambers. Each of the battery cells has a positive terminal at a first end, an opposite second end that defines the negative terminal, and a cylindrical sidewall that electrically communicates the negative terminal. The battery cells are supported in the cell chambers and the plurality of contacts contact the cylindrical sidewalls of the battery cells. The frame head is coupled to the frame closer to the first end of the battery cells than to the second end of the battery cells. The heat sink is coupled to the plurality of battery cell modules closer to the second end of the battery cells than to the first end of the battery cell module.

Other features and aspects of the disclosure will become apparent by consideration of the following detailed description and accompanying drawings.

### BRIEF DESCRIPTION OF THE DRAWINGS

FIG. 1 is a perspective view of a battery cell module according to the present disclosure.

FIG. 2 is a perspective view of the contact strap and battery cells of the battery cell module of FIG. 1.

FIG. 3 is a top view of a section of the contact strap of the battery cell module of FIG. 1.

FIG. 4 is a perspective view of the contact strap and a battery cell of the battery cell module of FIG. 1.

FIG. 5 is a top view of the frame, contact strap, and a plurality of battery cells of the battery cell module of FIG. 1.

FIG. 6 is a front view of at least a portion of the frame, contact strap, and a battery cell of the battery cell module of FIG. 1.

FIG. 7 is a perspective view of a battery cell stack according to the present disclosure.

FIG. 8 is a perspective view of at least a portion of the battery cell stack of FIG. 7.

FIG. 9 is a perspective view of the battery cell stack of FIG. 7, including a positive terminal connector.

FIG. 10 is a perspective view of the battery cell stack of FIG. 7, including a positive terminal connector.

FIG. 11 is a perspective view of the battery cell stack of FIG. 7, illustrating the heat sink.

FIG. 12 is a perspective view of a portion of the battery cell stack of FIG. 7.

FIG. 13 is a perspective view of a portion of the battery cell stack of FIG. 7.

FIG. 14 is a perspective view of another embodiment of a battery cell stack.

### DETAILED DESCRIPTION

Before any embodiments of the subject matter are explained in detail, it is to be understood that the subject matter is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting.

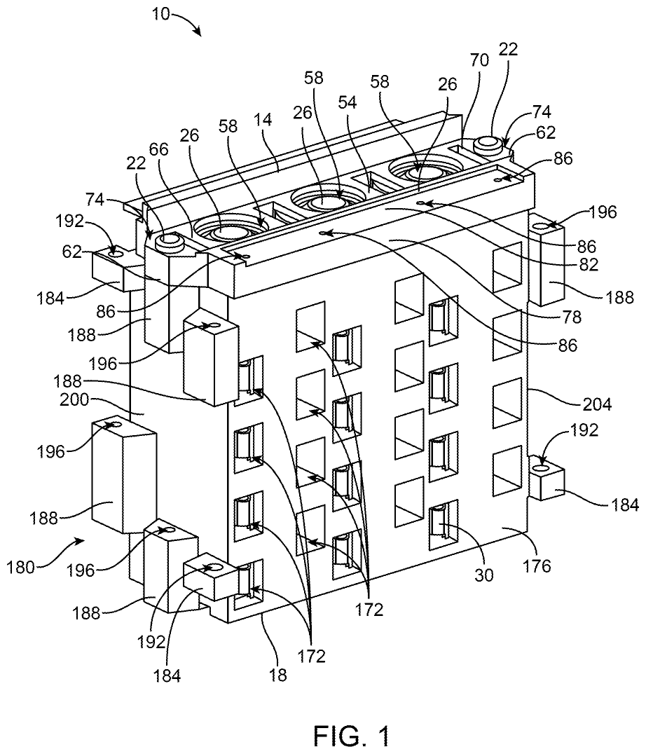

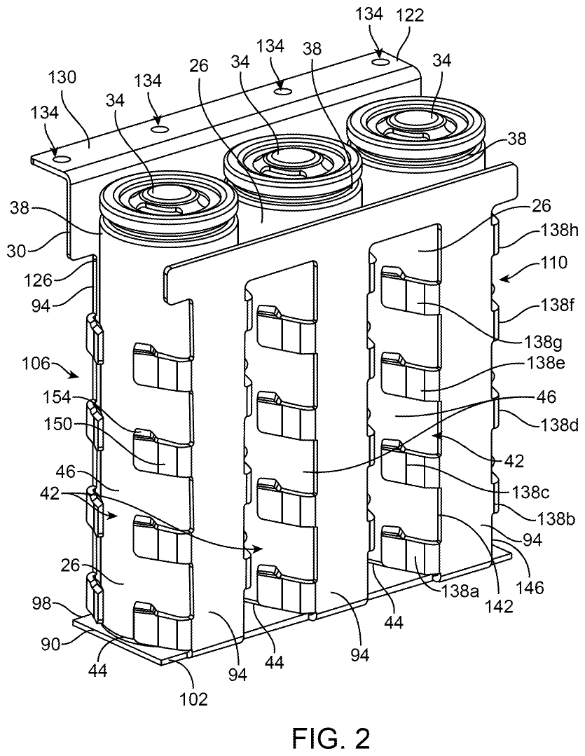

FIG. 1 illustrates an exemplary battery cell module 10 according to the present disclosure. The battery cell module 10 includes a frame head 14 coupled to a frame 18 (e.g., with fasteners 22) and one or more battery cells 26 supported by a contact strap 30 that is disposed within the frame 18. The frame head 14 and frame 18 are composed of a material that is not electrically conductive (e.g., plastic) and the contact strap 30 is composed of a material that is electrically conductive (e.g., copper, or another electrically conductive metal or metal alloy). As shown in FIG. 2, the battery cells 26 are cylindrical battery cells that have a positive terminal 34 at a first end 38, a negative terminal 42 that is defined by the opposite, second end 44 of the battery cell 26, and a cylindrical sidewall 46 that electrically communicates the negative terminal 42.

Returning with reference to FIG. 1, the frame head 14 includes a central portion 54 through which terminal holes 58 extend. As illustrated, the frame head 14 has three terminal holes 58 spaced equidistantly in a linear arrangement, although it will be appreciated that the number of terminal holes 58 can be increased or decreased to correspond with the number of battery cells 26 of the battery cell module 10. In other embodiments, other spacing and arrangement of the terminal holes 58 may be used. Coupling protrusions 62 extend from opposite ends 66, 70 of the central portion 54 and each coupling protrusion 62 includes a hole 74 through the coupling protrusion 62 that receives a fastener 22. A connector portion 78 extends from the central portion 54 between the coupling protrusions 62 and defines a coupling face 82. The coupling face 82 includes holes 86 spaced equidistantly along the coupling face 82 in a line, although other arrangements are possible. The holes 86 may include internal threading.

With reference to FIGS. 2-4, the contact strap 30 has a base portion 90 and support arms 94 that extend from the first side 98 and second side 102 of the base portion 90 in a direction substantially perpendicular to the base portion 90. While the support arms 94 that extend from the first side 98 of the base portion 90 are not shown in the figures, they are substantially the same as the support arms 94 extending from the second side 102 of the base portion 90. The support arms 94 extending from the first side 98 of the base portion 90 are a first support arm set 106 and the support arms 94 extending from the second side 102 of the base portion 90 are a second support arm set 110. The support arms 94 define support arm pairs 114, that is, a support arm 94 from the first support arm set 106 and a support arm 94 from the second support arm set 110 disposed opposite the support arm 94 of the first support arm set 106. The contact strap 30 is illustrated as having three support arm pairs 114. In other embodiments, the contact strap 30 may include a greater or lesser quantity of support arm pairs 114, depending on the desired quantity of battery cells 26. The contact strap 30 includes a busbar portion 122 that couples the ends 126 of the support arms 94 of the first support arm set 106 opposite the base portion 90. The busbar portion 122 includes a contact face 130 that extends substantially perpendicular to the first support arm set 106. The contact face 130 includes fastening holes 134 positioned equidistantly in a line along the contact face 130, although it will be appreciated that other arrangements are possible. The busbar portion 122 of the contact strap 30 comprises aluminum, copper, a copper alloy, clad, or other electrically conductive and metallically bondable material.

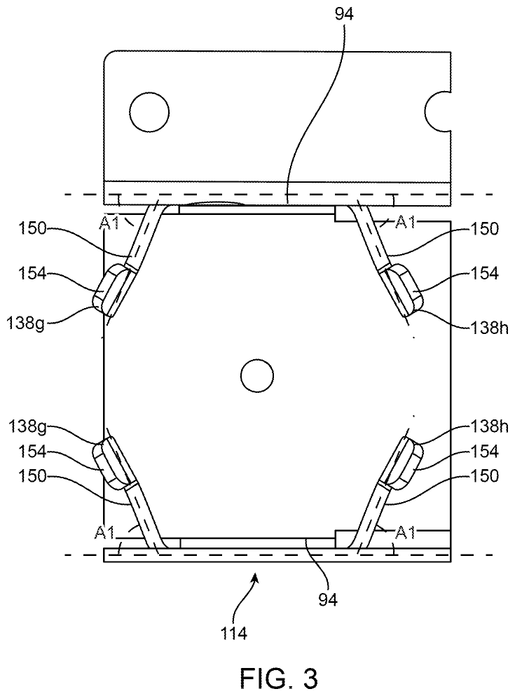

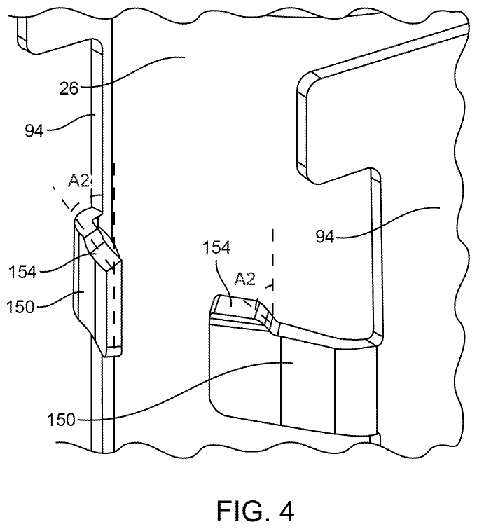

Contacts 138a-h extend from opposite first and second sides 142, 146 of the support arms 94 in an alternating pattern along the length of the support arm 94. That is, a first contact 138a extends from the first side 142 of the support arm 94 adjacent the base portion 90, a second contact 138b extends from the opposite second side 146 of the support arm 94 offset from the first contact 138a and the base portion 90 along the length of the support arm 94. Each subsequent odd-numbered contact 138c, 138e, 138g extends from the first side 142 of the support arm 94 and is offset from the previous contacts and each subsequent even-numbered contact 138 d, 138f, 138g extends from the second side 146 of the support arm 94 and is offset from the previous contacts. As illustrated, each support arm 94 includes eight contacts 138a-h extending therefrom. It will be appreciated that other quantities and arrangements of the contacts are possible. As best illustrated in FIGS. 3 and 4, each contact 138a-h includes an arm portion 150 that extends at an angle A1 from the support arm 94 toward the opposite support arm 94 of the support arm pair 114 and a guide portion 154 that extends from the arm portion 150 in an upward direction away from the base portion 90 and outward at an angle A2 away from the opposite support arm 94. In one embodiment, the angle A1 may have a measurement of less than 90 degrees, such as an angle A1 having a measurement between 45 degrees and 80 degrees, such as 75 degrees. In other embodiments, the angle A1 may have a different measurement. In one embodiment, the angle A2 may have a measurement greater than 0 degrees, such as an angle A2 having a measurement range between 30 degrees and 60 degrees, such as an angle A2 measuring 45 degrees.

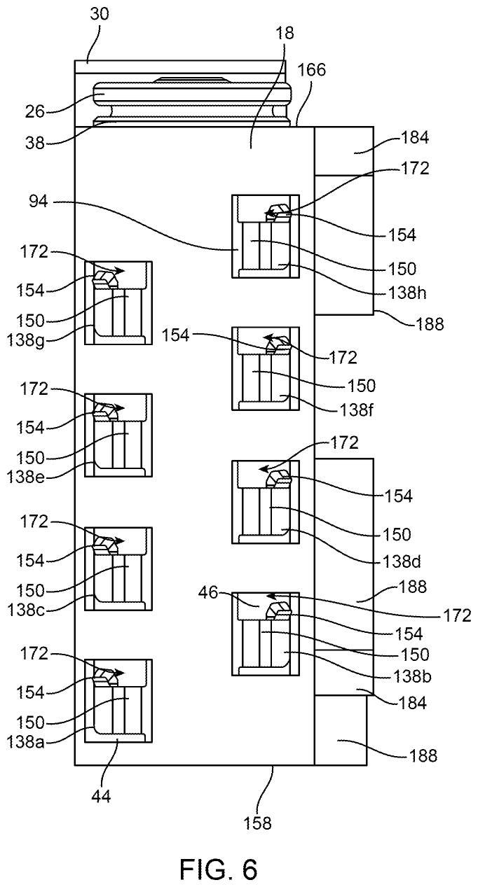

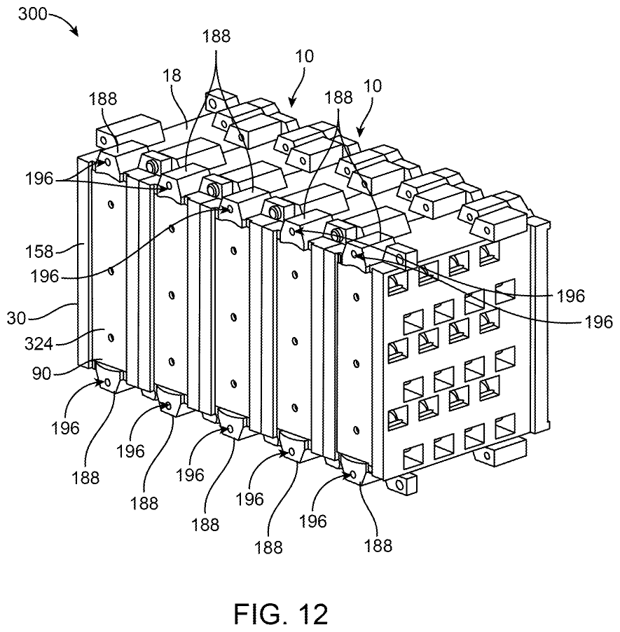

With reference to FIGS. 1, 5, and 6, the frame 18 has a substantially cuboid body that supports and at least partially envelops the contact strap 30. The contact strap 30 is integrally formed (e.g., by an insert molding process) with the frame 18. In other embodiments, the contact strap 30 may be separately formed and coupled with the frame 18, for instance, via mechanical fasteners, adhesive, etc. As shown in FIG. 12, the base portion 90 of the contact strap 30 is substantially flush with the bottom surface 158 of the frame 18. Returning with reference to FIGS. 1, 5, and 6, cell chambers 160 extend from insertion holes 162 spaced along the top surface 166. The cell chambers 160 are arranged in a linear, evenly spaced arrangement, with a support arm pair 114 supported in each cell chamber 160 and contacts 138a-h spaced along each cell chamber 160. It will be appreciated that the cell chambers 160 may be positioned in other arrangements. The frame 18 is illustrated as having three cell chambers 160. In other embodiments, the number of cell chambers 160 may be increased or decreased depending on the desired number of battery cells 26 included in the battery cell module 10. Airflow holes 172 having a substantially rectangular shape are spaced about the front face 176 and rear face 178 of the frame 18 and extend through the frame 18 in a direction substantially perpendicular to the cell chambers 160. In other embodiments, the airflow holes 172 may have another shape. The airflow holes 172 are aligned with the contacts 138a-h of the contact strap 30.

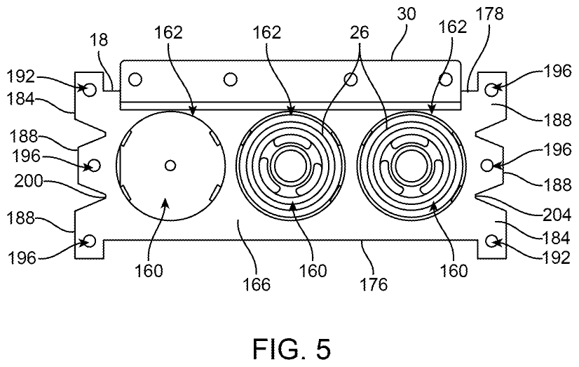

The frame 18 includes coupling structures 180 such as tabs 184 and projections 188 that extend from the frame 18. The coupling structures 180 are configured to couple a frame 18 to an adjacent frame 18. Each tab 184 includes a through hole 192. Each projection 188 includes an internally threaded bore 196. The coupling structures 180 are disposed on the ends 200, 204 adjacent the front face 176 and rear face 178. As shown in the FIG. 5, the tabs 184 and projections 188 extend forward of the front face 176 (illustrated as toward the bottom of the page) and rearward of the rear face 178 (illustrated as toward the top of the page). One tab 184 is disposed adjacent the bottom surface 158 of the frame 18 adjacent the front face 176 and a second tab 184 is disposed adjacent the top surface 166 of the frame 18 adjacent the rear face 178. As further illustrated, one projection 188 is positioned adjacent the top surface 166 of the frame 18 adjacent the front face 176 and a second projection 188 is positioned adjacent the bottom surface 158 of the frame 18 adjacent the rear face 178. Other projections 188 extend from the ends 200, 204 adjacent the bottom and top surfaces 158, 166 of each frame 18 between the front and rear faces 176, 178. In other embodiments, the coupling structures 180 may be arranged at other positions on the frame 18 and may include other configurations. In other embodiments, adjacent frames 18 may be coupled in another manner.

In a battery cell module 10 that includes a frame 18 integrally formed with the contact strap 30, the battery cell module 10 is assembled by inserting the second end 44 of each battery cell 26 into the cell chamber 160 through the insertion hole 162 of the frame 18. As each battery cell 26 is inserted into a cell chamber 160, the second end 44 of the battery cell 26 engages the guide portion 154 of each of the contacts 138a-h and elastically deforms the arm portion 150 of the contacts 138a-h. The arm portions 150 are biased, as a spring, to return to the undeformed position and thereby, into continuous engagement with the cylindrical sidewall 46 of the battery cell 26 at contact locations. When fully inserted into the cell chamber 160, the second end 44 of each battery cell 26 engages the base portion 90 of the contact strap 30 and the positive terminal 34 of each battery cell 26 extends above the top surface 166 of the frame 18.

Engagement of the contacts 138a-h with the cylindrical sidewall 46 of the battery cell 26 establishes an electrical connection between the cylindrical sidewall 46 and thereby the negative terminal 42 of the battery cell 26 and the contact strap 30. Establishing an electrical connection in this manner reduces the number of steps in the assembly process by combining the steps of assembling the battery cells 26 in the frame 18 and electrically coupling the battery cells 26 to a busbar (e.g., the contact strap 30) into one, streamlined step. In battery cells requiring additional processing (e.g., laser cleaning) to establish a negative connection location, for instance, at the crimp of the cylindrical sidewall 46, the assembly process is further streamlined. The number of contact locations of the contact strap 30 with the cylindrical sidewall 46 of the battery cells 26 reduces the power hot spots on each battery cell 26. The number and configuration of the contacts 138a-h of the contact strap 30 also reduces the contact resistance in comparison to a battery cell module having a wire-bonded connection to the crimp of a battery cell.

The frame head 14 is coupled to the frame 18 nearer to the first end 38 of the battery cells 26 than to the second end 44 of the battery cells 26 via fasteners 22 threadedly engaging the internally threaded bores 196 of the projections 188 adjacent the top surface 166 of the frame 18. The frame head 14 maintains the battery cells 26 within the cell chambers 160. The terminal holes 58 of the frame head 14 are aligned with the insertion holes 162 of the frame 18 and cell chambers 160.

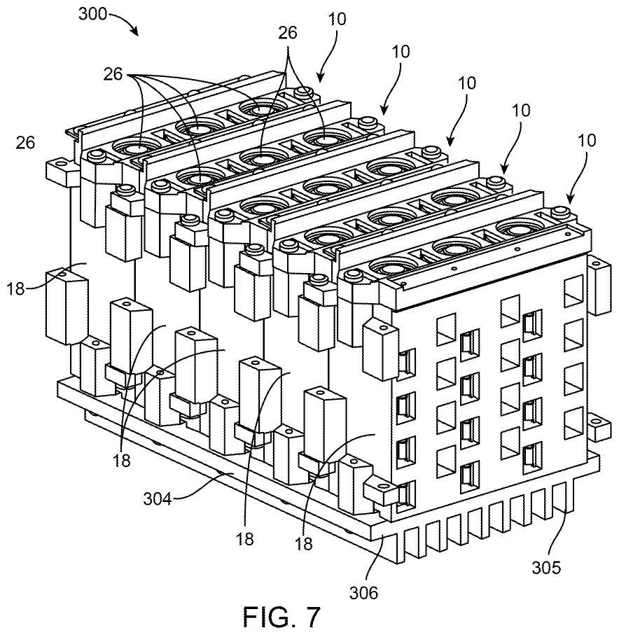

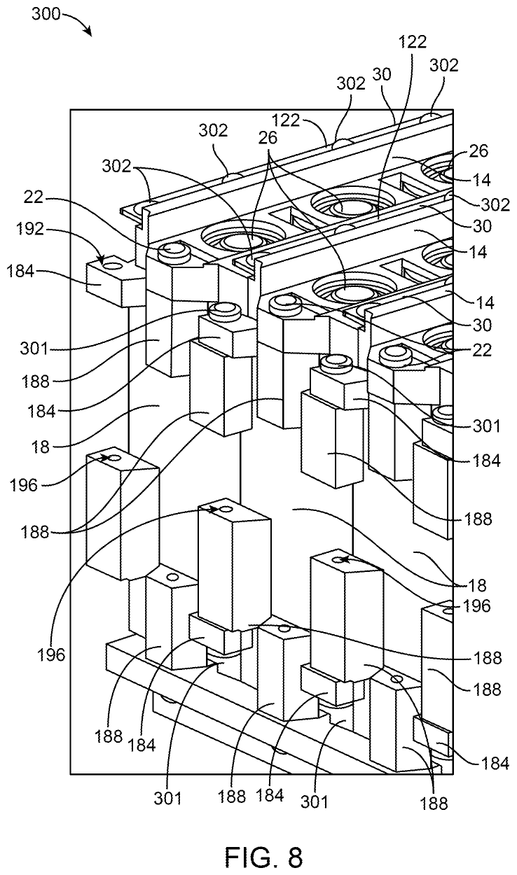

With reference to FIGS. 7-10, a battery cell module 10 is couplable with other battery cell modules 10 to form a battery cell stack 300. The battery cell stack 300 provides a power source of a battery pack, a portable power unit, or other electrical power source for a tool, a worksite, etc. The battery cell stack 300 as illustrated includes five battery cell modules 10 having three battery cells 26 per battery cell module 10 for a total of fifteen battery cells 26, although the battery cell modules 10 may be coupled in different quantities to provide battery cell stacks 300 with varying voltage and power capacities, thereby offering a customizable battery cell stack 300 that is configurable for the desired application.

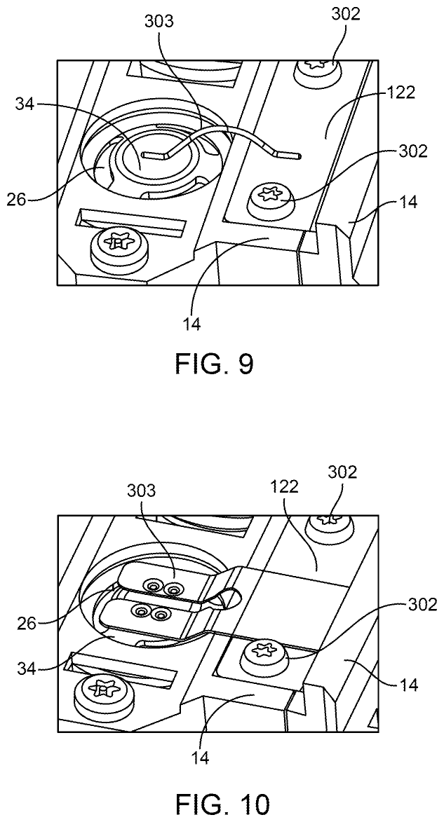

Assembly of the battery cell stack 300 is accomplished by coupling the frames 18 of adjacent battery cell modules 10 via fasteners 301 that engage the tabs 184 and projections 188 of the adjacent frames 18. The busbar portion 122 of battery cell module 10 is connected (e.g., with fasteners 302) to the coupling face 82 of the frame head 14 of the adjacent battery cell module 10. As assembled, the busbar portion 122 is nearer to the first end 38 of the battery cells 26 than to the second end 44 of the battery cells 26. The battery cells 26 of each battery cell module 10 are coupled to the other battery cells 26 of the cell module 10 in a parallel electrical connection and each battery cell module 10 is coupled to other battery cell modules 10 in a series connection. Connectors 303 (e.g., a wire of a wire bonding connection, illustrated in FIG. 9, or a resistance welding tab of a resistance welding process, illustrated in FIG. 10, or other connector of an electrical coupling process) electrically connect the positive terminal 34 of each battery cell 26 to the busbar portion 122 of an adjacent cell module 10.

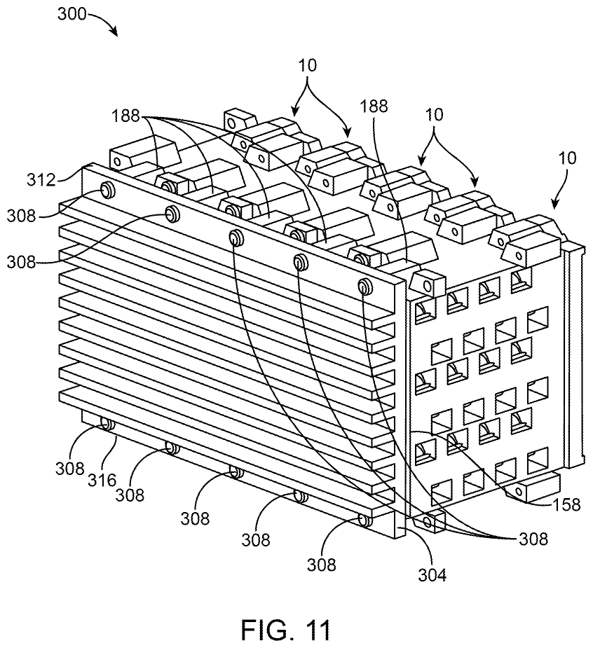

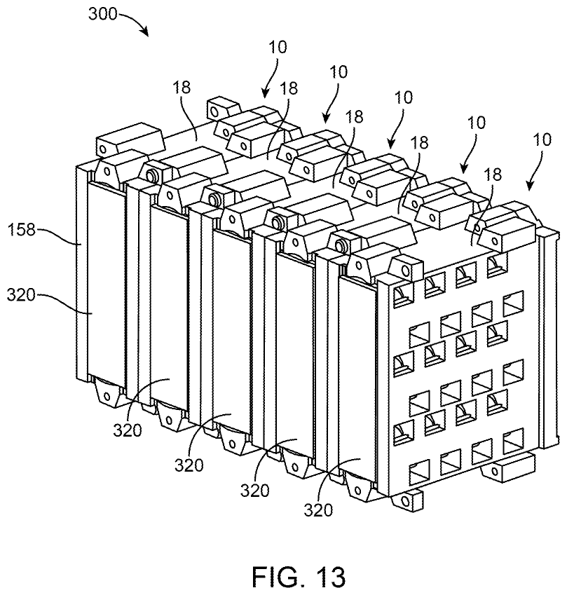

With reference to FIGS. 7 and 11-13, the battery cell stack 300 may include a heat sink 304 (e.g., an aluminum heat sink having fins 305 extending from a base portion 306) for removal of heat from the battery cell modules 10. The heat sink 304 is coupled to the battery cell modules 10 by fasteners 308 (FIG. 11) spaced along the first and second sides 312, 316 of the heat sink 304 that threadedly engage the internally threaded bores 196 of the projections 188 adjacent the bottom surface 158 of the frame 18 and the second ends 44 of the battery cells 26. It will be appreciated that the heat sink 304 may be coupled to the battery cell modules 10 in another manner. A thermally conductive and electrically insulative material 320 is coupled to the bottom face 324 of the base portion 90 of the contact strap 30 and to the base portion 306 of the heat sink 304, providing a thermal pathway to the heat sink 304 for thermal dissipation of the heat generated by the battery cells 26, while preventing discharge of electricity from the battery cells 26 to the heat sink 304.

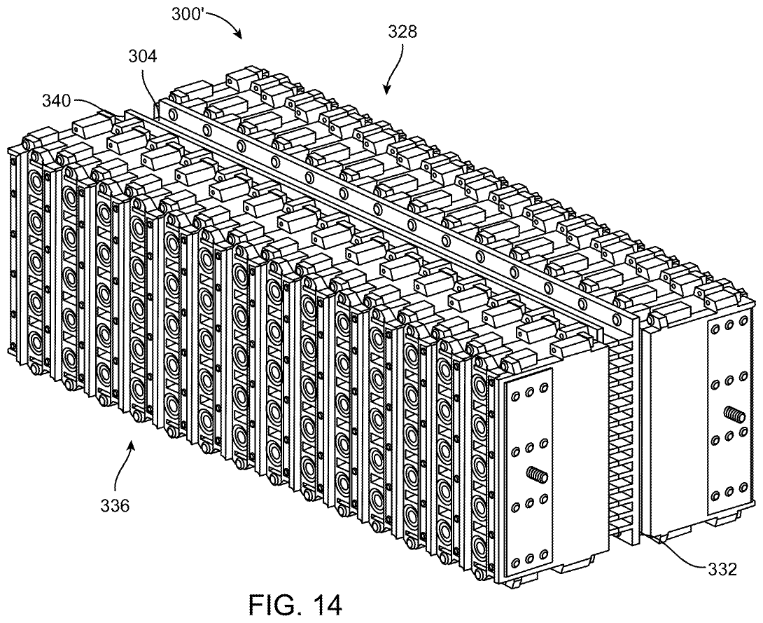

In another embodiment, illustrated in FIG. 14, the battery cell stack 300′ includes battery cell modules 10 comprising a first set 328 coupled to one side 332 of a heat sink 304 and battery cell modules 10 comprising a second set 336 coupled to the opposite side 340 of the heat sink 304 such that the heat sink 304 is positioned between the two sets 328, 336 of battery cell modules 10.

Various features of the subject matter are set forth in the following claims.

Although the subject matter has been described in detail with reference to certain preferred embodiments, variations and modifications exist within the scope and spirit of one or more independent aspects of the subject matter as described.

What is claimed is:

1. A battery cell module comprising:
a frame defining a plurality of cell chambers;
a contact strap supported in the frame, the contact strap including a plurality of contacts spaced along each of the cell chambers;
a plurality of battery cells, each of the battery cells having a positive terminal at a first end, a second end defining a negative terminal, and a cylindrical sidewall electrically communicating the negative terminal, the battery cells supported in the cell chambers, the plurality of contacts contacting the cylindrical sidewalls of the battery cells.

2. The battery cell module of claim 1, wherein the contact strap includes a plurality of support arms from which the contacts extend.

3. The battery cell module of claim 2, wherein the contacts extend from alternating sides of the support arms.

4. The battery cell module of claim 1, wherein the contact strap defines a base portion from which the plurality of support arms extend, the second end of the battery cells contacting the base portion.

5. The battery cell module of claim 2, wherein the plurality of support arms includes a first set of support arms, the contact strap further including a second set of a plurality of support arms from which the contacts extend.

6. The battery cell module of claim 1, wherein each of the contacts includes a guide portion engageable with the second end during insertion of the battery cell into the cell chamber.

7. The battery cell module of claim 1, wherein the frame includes a plurality of airflow holes.

8. The battery cell module of claim 7, wherein the airflow holes are aligned with the contacts.

9. The battery cell module of claim 1, further comprising a frame head coupled to the frame adjacent the first end of the battery cells.

10. The battery cell module of claim 9, wherein the frame head includes a coupling face adjacent the first end of the battery cells.

11. A battery cell stack comprising:
a plurality of battery cell modules, each battery cell module including
a frame defining a plurality of cell chambers;
a contact strap supported in the frame, the contact strap including a plurality of contacts spaced along each of the cell chambers;
a plurality of battery cells, each of the battery cells having a positive terminal at a first end, an opposite second end defining a negative terminal, and a cylindrical sidewall electrically communicated with the negative terminal, the battery cells supported in the cell chambers, the plurality of contacts contacting the cylindrical sidewalls of the battery cells;
a frame head coupled to the frame nearer to the first end of the battery cells than to the second end of the battery cells; and
a heat sink coupled to the plurality of battery cell modules nearer to the second end of the battery cells than to the first end of the battery cells.

12. The battery cell stack of claim 11, wherein the contact strap includes a busbar portion nearer to the first end of the battery cells than to the second end of the battery cells, the busbar portion of a first battery cell module coupled to the frame head of a second battery cell module adjacent the first battery cell module.

13. The battery cell stack of claim 12, further comprising a plurality of connectors, each connector coupled to the positive terminal of each of the battery cells and to the busbar portion of the adjacent battery cell module.

14. The battery cell stack of claim 11, wherein the contact strap includes a base portion contacting the second ends of the battery cells of each of the cell modules, the base portion thermally coupled to the heat sink.

15. The battery cell stack of claim 14, wherein the base portion is coupled to the heat sink via a thermally conductive and electrically insulative material.

16. The battery cell stack of claim 11, wherein the plurality of battery cell modules is a first plurality of battery cell modules coupled to a first side of the heat sink, the battery cell stack further comprising a second plurality of battery cell modules coupled to a second side of the heat sink.

17. A battery cell module comprising:
a plurality of battery cells, each of the battery cells having a positive terminal at a first end, an opposite second end defining a negative terminal, and a cylindrical sidewall electrically communicating the negative terminal;
a frame having a top surface and plurality of cell chambers extending therefrom, the cell chambers receiving the plurality of battery cells;
a contact strap supported in the frame, the contact strap including
a base portion contacting the second end of the battery cells,
a first support arm extending from a first side of the base portion, a second support arm extending from an opposite second side of the base portion, each of the support arms including a plurality of contacts extending from the support arm and spaced along the support arm, the contacts engaging the cylindrical sidewall of the battery cell,
a busbar portion disposed on an end of the first support arm, the busbar portion including a contact face extending perpendicular to the first support arm;
a frame head coupled to the frame, the frame head including a plurality of terminal holes aligned with the cell chambers.

18. The battery cell module of claim 17, wherein the contacts extend from alternating sides of the support arms.

19. The battery cell module of claim 17, wherein the frame includes a plurality of airflow holes spaced about a first side and an opposite second side, the airflow holes aligned with the plurality of contacts.

20. The battery cell module of claim 17, wherein the frame head includes a coupling face adjacent the plurality of terminal holes.
